(19) United States
(12) Patent Application Publication
(10) Pub. No.: US 2025/0048394 A1
(43) Pub. Date: Feb. 6, 2025

(54) ENHANCED SIDELINK COLLISION AVOIDANCE BASED ON SENSING OF RECEIVER FEEDBACK

(71) Applicant: Nokia Technologies Oy, Espoo (FI)

(72) Inventors: Daniel MEDINA, Munich (DE); Nuno Manuel KIILERICH PRATAS, Gistrup (DK); Ling YU, Kauniainen (FI); Vinh VAN PHAN, Oulu (FI); Berthold PANZNER, Holzkirchen (DE); Torsten WILDSCHEK, Gloucester (GB); Stepan KUCERA, Munich (DE); Lianghai JI, Aalborg (DK)

(21) Appl. No.: 18/717,471

(22) PCT Filed: Dec. 7, 2022
(86) PCT No.: PCT/EP2022/084717

§ 371 Date: Jun. 7, 2024

Related U.S. Application Data
(60) Provisional application No. 63/289,932, filed on Dec. 15, 2021.

(51) Int. Cl. H04W 72/25; H04L 5/00; H04W 72/0453

(52) U.S. Cl. CPC H04W 72/25; H04L 5/0094; H04W 72/0453

(57) ABSTRACT

Systems, methods, and apparatuses for sidelink collision avoidance based on sensing, such as PSFCH sensing, are provided. One method may include sensing, by a first UE, a first sidelink feedback transmission from a second UE in a first PSFCH resource, and determining, based on the first PSFCH resource, a first radio resource in which the second UE received a first data transmission from a third UE. The method may also include sensing a second sidelink feedback transmission from the second UE in a second PSFCH resource, determining, based on the second PSFCH resource, a second radio resource in which the second UE received a second data transmission from the third UE, and determining, based on at least one of the determined first radio resource or second radio resource, a third radio resource in which the second UE is expected to receive a third data transmission from the third UE.

### FIELD

Some example embodiments may generally relate to communications including mobile or wireless telecommunication systems, such as Long Term Evolution (LTE) or Fifth Generation (5G) radio access technology or New Radio (NR) access technology, or other communications systems. For example, certain example embodiments may generally relate to systems and/or methods for NR sidelink collision avoidance based on sensing of receiver feedback.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or Fifth Generation (5G) radio access technology or New Radio (NR) access technology. 5G wireless systems refer to the Next Generation (NG) of radio systems and network architecture. A 5G system is mostly built on a 5G New Radio (NR), but a 5G (or NG) network can also build on the E-UTRA radio. It is estimated that NR provides bitrates on the order of 10-20 Gbit/s or higher, and can support at least service categories such as enhanced Mobile Broadband (eMBB) and Ultra-Reliable Low-Latency Communication (URLLC) as well as massive Machine Type Communication (mMTC). NR is expected to deliver extreme broadband and ultra-robust, low-latency connectivity and massive networking to support the Internet of Things (IoT). With IoT and Machine-to-Machine (M2M) communication becoming more widespread, there will be a growing need for networks that meet the needs of lower power, low data rate, and long battery life. The Next Generation Radio Access Network (NG-RAN) represents the RAN for 5G, which can provide both NR and LTE (and LTE-Advanced) radio access. It is noted that, in 5G, the nodes that can provide radio access functionality to a User Equipment (UE) (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY:

An embodiment may be directed to an apparatus including at least one processor and at least one memory comprising computer program code, the at least one memory and computer program code configured, with the at least one processor, to cause the apparatus at least to: sense a first sidelink feedback transmission from a receiver user equipment (UE) in a first Physical Sidelink Feedback Channel (PSFCH) resource; determine, based on the first Physical Sidelink Feedback Channel (PSFCH) resource, a first radio resource in which the receiver user equipment (UE) received a first data transmission from a transmitter user equipment (UE); sense a second sidelink feedback transmission from the receiver user equipment (UE) in a second Physical Sidelink Feedback Channel (PSFCH) resource; determine, based on the second Physical Sidelink Feedback Channel (PSFCH) resource, a second radio resource in which the receiver user equipment (UE) received a second data transmission from the transmitter user equipment (UE); and determine, based on at least one of the determined first radio resource or second radio resource, a third radio resource in which the receiver user equipment (UE) is expected to receive a third data transmission from the transmitter user equipment (UE).

An embodiment may be directed to an apparatus including means for sensing a first sidelink feedback transmission from a receiver user equipment (UE) in a first Physical Sidelink Feedback Channel (PSFCH) resource, and means for determining, based on the first Physical Sidelink Feedback Channel (PSFCH) resource, a first radio resource in which the receiver user equipment (UE) received a first data transmission from a transmitter user equipment (UE). The apparatus may also include means for sensing a second sidelink feedback transmission from the receiver user equipment (UE) in a second Physical Sidelink Feedback Channel (PSFCH) resource, and means for determining, based on the second Physical Sidelink Feedback Channel (PSFCH) resource, a second radio resource in which the receiver user equipment (UE) received a second data transmission from the transmitter user equipment (UE). The apparatus may further include means for determining, based on at least one of the determined first radio resource or second radio resource, a third radio resource in which the receiver user equipment (UE) is expected to receive a third data transmission from the transmitter user equipment (UE).

An embodiment may be directed to a method including sensing, by a first user equipment, a first sidelink feedback transmission from a second user equipment (UE) in a first Physical Sidelink Feedback Channel (PSFCH) resource, and determining, based on the first Physical Sidelink Feedback Channel (PSFCH) resource, a first radio resource in which the second user equipment (UE) received a first data transmission from a third user equipment (UE). The method may also include sensing, by the first user equipment, a second sidelink feedback transmission from the second user equipment (UE) in a second Physical Sidelink Feedback Channel (PSFCH) resource, determining, based on the second Physical Sidelink Feedback Channel (PSFCH) resource, a second radio resource in which the second user equipment (UE) received a second data transmission from the third user equipment (UE), and determining, based on at least one of the determined first radio resource or second radio resource, a third radio resource in which the second user equipment (UE) is expected to receive a third data transmission from the third user equipment (UE).

In some embodiments, the first and second radio resources comprise a same subchannel in frequency.

According to an embodiment, the method may include deprioritizing or excluding from a set of candidate radio resources, for transmission by the first user equipment (UE), a candidate radio resource that at least partially overlaps with the determined third radio resource.

In an embodiment, the method may include triggering radio resource reselection if the determined third radio resource at least partially overlaps with a radio resource reserved for transmission by the first user equipment (UE).

According to an embodiment, at least one of the deprioritization or exclusion of the overlapping candidate radio resource or the triggering of radio resource reselection is based on a measured signal strength of the first or second sidelink feedback transmissions.

In an embodiment, at least one of the deprioritization or exclusion of the overlapping candidate radio resource or the triggering of radio resource reselection is based on a number of periodically recurring data transmissions determined by the first user equipment (UE) based on sensed sidelink feedback transmissions from the second user equipment (UE).

According to an embodiment, at least one of the deprioritization or exclusion of the overlapping candidate radio resource or the triggering of radio resource reselection is based on a number of overlapping subchannels.

In an embodiment, at least one of the deprioritization or exclusion of the overlapping candidate radio resource or the triggering of radio resource reselection is based on a probability distribution over a number of contiguous subchannels for the third data transmission.

According to an embodiment, the probability distribution over the number of contiguous subchannels for the third data transmission is determined based on at least one of a configured minimum or maximum number of contiguous subchannels.

In an embodiment, at least one of the deprioritization or exclusion of the overlapping candidate radio resource or the triggering of radio resource reselection is based on a probability distribution over a starting subchannel for the third data transmission.

According to an embodiment, the probability distribution over the starting subchannel for the third data transmission is determined based on a determined subchannel of at least one of the first or second data transmission.

In an embodiment, the determined third radio resource comprises a configured minimum or maximum number of contiguous subchannels for the third data transmission, starting with a determined subchannel of at least one of the first data transmission or second data transmission.

According to an embodiment, the determined third radio resource comprises all subchannels located, with respect to a determined subchannel of at least one of the first data transmission or second data transmission, within a distance smaller than a configured minimum or maximum number of contiguous subchannels for the third data transmission.

In an embodiment, the exclusion of the overlapping candidate radio resource depends on a remaining fraction of non-excluded candidate radio resources.

According to an embodiment, the sensing of at least one of the first sidelink feedback transmission or the second sidelink feedback transmission is performed on a beam being used or to be used for transmission by the first user equipment.

### BRIEF DESCRIPTION OF THE DRAWINGS:

For proper understanding of example embodiments, reference should be made to the accompanying drawings, wherein:

FIG. 1 illustrates an instance where a transmitter UE selects a radio resource overlapping with a radio resource reserved for transmission by a hidden UE, according to one example;

FIG. 2 illustrates an instance where a transmitter UE selects a radio resource overlapping with a radio resource reserved for transmission by another UE when using beamforming, according to one example;

FIG. 3 illustrates an example where a transmitter UE senses a Physical Sidelink Feedback Channel (PSFCH) transmission by a neighboring UE, according to an example embodiment;

FIG. 4 illustrates an example where a transmitter UE infers a radio resource reserved for transmission by a hidden UE based on a sensed PSFCH transmission, according to one example embodiment;

FIG. 5 illustrates an example where a transmitter UE senses PSFCH transmissions associated with Physical Sidelink Shared Channel (PSSCH) transmissions from multiple hidden UEs, according to certain example embodiments;

FIG. 6 illustrates an example of a PSFCH-to-PSSCH resource mapping, according to an example embodiment;

FIG. 7 illustrates an example flow diagram of a method, according to an example embodiment;

FIGS. 8A and 8B illustrate an example of PSFCH sensing with beamforming, according to some example embodiments;

FIG. 9 illustrates another example of PSFCH sensing with beamforming, according to some example embodiments;

FIG. 10 illustrates an example flow diagram of a method, according to an example embodiment;

FIG. 11A illustrates an example block diagram of an apparatus, according to an embodiment; and

FIG. 11B illustrates an example block diagram of an apparatus, according to an embodiment.

### DETAILED DESCRIPTION:

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for sidelink collision avoidance based on sensing of receiver feedback, such as Physical Sidelink Feedback Channel (PSFCH) sensing, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

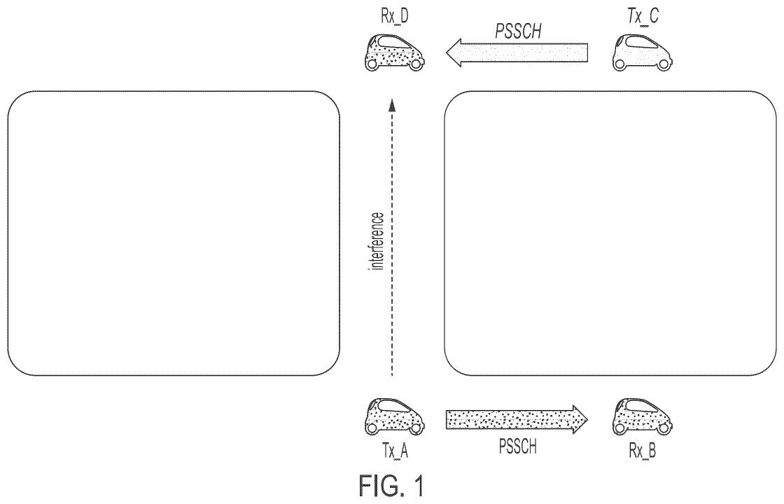

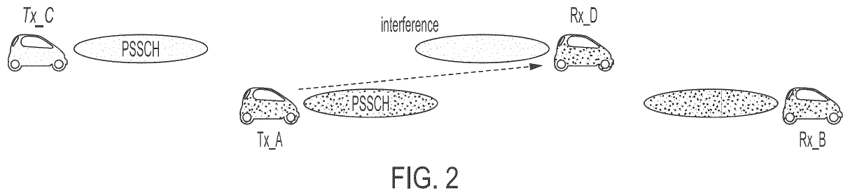

In Third Generation Partnership Project (3GPP) Release-16, a transmitter UE (Tx_A in the example of FIGS. 1 and 2) may use sensing, i.e., Physical Sidelink Control Channel (PSCCH) decoding, to determine sidelink radio resources to be excluded from its radio resource selection for sidelink transmission to a receiver UE (e.g., Rx_B in the example of FIGS. 1 and 2). In this way, collisions may be avoided. FIG. 1 illustrates an example in which the transmitter UE (Tx_A) selects a radio resource overlapping with a radio resource reserved for transmission by a hidden UE (Tx_C). As shown in the example of FIG. 1, the transmitter UE (Tx_A) may not be able to sense transmission(s) by the hidden UE (Tx_C) and, thus, there is a non-zero chance that the transmitter UE (Tx_A) may select a radio resource overlapping with a radio resource reserved for transmission by the hidden UE (Tx_C). As a result, an intended recipient, e.g., Rx_D, of the hidden UE's (Tx_C) transmission(s) may experience interference from the transmitter UE (Tx_A) (i.e., the collision could not be avoided).

FIG. 2 illustrates another situation in which a transmitter UE (Tx_A) may not be able to sense transmission(s) from another UE (Tx_C). In the example of FIG. 2, the transmitter UE (Tx_A) may perform sensing within a beam to be used for transmission to a corresponding receiver UE (Rx_B). As a result of beamforming, transmissions from another UE (such as Tx_C) located outside of the beam may be received by the transmitter UE (Tx_A) with insufficient signal strength to decode the corresponding Sidelink Control Information (SCI). Consequently, the transmitter UE (Tx_A) may select a radio resource overlapping with a radio resource reserved for transmission by the other UE (Tx_C), thus interfering with reception at a corresponding receiver UE (Rx_D) located within the beam.

As will be discussed below, certain embodiments may exploit the implicit resource mapping between the Physical Sidelink Shared Channel (PSSCH) and PSFCH. Example embodiments do not result in added signaling or overhead.

Certain embodiments may provide a device (e.g., a first UE) and method for enhanced collision avoidance, for example, in NR sidelink (SL) mode 2. According to an embodiment, by monitoring PSFCH transmissions from a neighbor device (e.g., a second UE), and taking advantage of an implicit PSSCH-to-PSFCH resource mapping standardized in Release-16 NR sidelink, the device (first UE) may be able to determine a radio resource in which the neighbor device (second UE) is expected to receive PSSCH. Based on its expectation, the device (first UE) can deprioritize or exclude from radio resource selection, for its own transmission, one or more candidate radio resources that overlap with the determined radio resource, in order to avoid a collision. In addition, according to an embodiment, if the determined radio resource overlaps with a radio resource already reserved for its own transmission, the device (first UE) may trigger resource reselection to avoid interfering with PSSCH reception at the neighbor device (second UE).

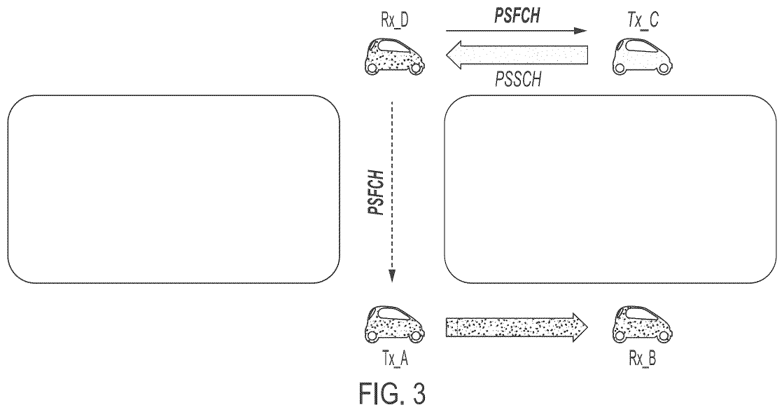

In an embodiment, to enhance collision avoidance in NR sidelink mode 2 and address the hidden node issue, a first UE (Tx_A) may be configured to monitor PSFCH transmission(s) from a second UE (Rx_D), as illustrated in the example of FIG. 3. Such PSFCH transmission(s) may convey acknowledgment(s) (positive or negative) of PSSCH transmission(s) received by the second UE (Rx_D) from a third UE (Tx_C) (in case receiver feedback is enabled/configured), which may be hidden from the first UE (Tx_A).

When performing radio resource (re) selection for its own PSSCH transmission (e.g., to a fourth UE (Rx_B) and/or to the second UE (Rx_D)), the first UE (Tx_A) may not be able to sense (i.e., decode PSCCH) transmissions from the third UE (Tx_C). However, the first UE (Tx_A) may take advantage of the monitored PSFCH transmission(s) from the second UE (Rx_D).

The first UE (Tx_A) may infer the presence of periodic (or semi-persistent) PSSCH transmissions from the third UE (Tx_C) to the second UE (Rx_D) based on its having monitored one or more PSFCH transmission(s) from the second UE (Rx_D).

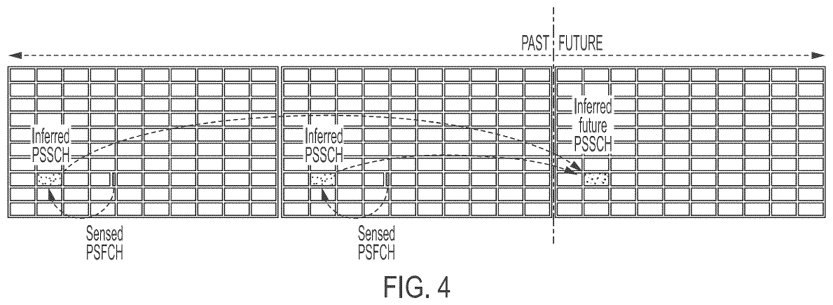

FIG. 4 illustrates an example in which a transmitter UE (Tx_A) infers a radio resource reserved for transmission by a hidden UE (Tx_C) based on sensed PSFCH, according to an embodiment. For example, as shown in the example of FIG. 4, the first UE (Tx_A) may monitor a first PSFCH transmission by the second UE (Rx_D) and determine a first time-frequency resource (slot and subchannel) in which a first PSSCH transmission from the third UE (Tx_C) was received by the second UE (Rx_D). This is possible due to a standardized implicit resource mapping between the time-frequency location of the PSSCH transmission by the third UE (Tx_C) to the second UE (Rx_D) and the corresponding PSFCH transmission by the second UE (Rx_D) to the third UE (Tx_C), as will be explained in further detail below.

Similarly, the first UE (Tx_A) may monitor a second PSFCH transmission by the second UE (Rx_D) and determine a second time-frequency resource (slot and subchannel) in which a second PSSCH transmission from the third UE (Tx_C) was received by the second UE (Rx_D).

Based on the first and second determined time-frequency resources in which the first and second PSSCH transmissions from the third UE (Tx_C) were received by the second UE (Rx_D), respectively, the first UE (Tx_A) may determine a third time-frequency resource (slot and subchannel) in which the first UE (Tx_A) expects that a third PSSCH transmission from the third UE (Tx_C) will be received by the second UE (Rx_D). For example, as shown in the example of FIG. 4, the first and second determined time-frequency resources may occur in the same subchannel (frequency domain) separated by a time interval of ten slots (time domain). Thus, the first UE (Tx_A) may predict a third PSSCH transmission is likely to occur in the same subchannel, ten slots after the second PSSCH transmission (i.e., corresponding to a periodicity of ten slots). Naturally, the prediction may become more reliable as the number of periodically recurring PSSCH transmissions determined by the first UE (Tx_A), based on the monitored PSFCH transmissions, increases.

In some cases, such as where a wireless network is configured in a manner that all PSSCH transmissions in a resource pool are by default semi-persistent and have a common periodicity (e.g., in industrial automation), it may suffice for the first UE (Tx_A) to determine a single PSSCH transmission (e.g., the first or second PSSCH transmission) based on a single monitored PSFCH transmission by the second UE (Rx_D).

In an embodiment, based on its prediction, the first UE (Tx_A) may be configured to deprioritize or exclude from a candidate resource set for its own transmission candidate resources that overlap, at least partially, with the determined third time-frequency resource (slot and subchannel) in which the first UE (Tx_A) expects a third PSSCH transmission from the third UE (Tx_C) will be received by the second UE (Rx_D). In this way, the first UE (Tx_A) may avoid interfering with reception at the second UE (Rx_D), which might otherwise lead to a resource reselection by the third UE (Tx_C), and potentially further resource reselections by other UEs further away, creating a chain reaction that might degrade system performance.

According to certain embodiments, the extent to which the first UE (Tx_A) deprioritizes an overlapping candidate resource (or the decision whether or not to exclude the candidate resource from resource selection) may be based on a signal strength, measured at the first UE (Tx_A), of the PSFCH transmission(s) by the second UE (Rx_D). For example, if the first UE (Tx_A) measures a strong signal, the second UE (Rx_D) is likely to be in close proximity of the first UE (Tx_A), and consequently the interference that would be caused to the second UE (Rx_D) would be significant. Thus, the first UE (Tx_A) may deprioritize an overlapping candidate resource more aggressively (or even exclude it). On the other hand, if the first UE (Tx_A) measures a weak signal, the second UE (Rx_D) is likely to be farther away, and consequently the interference that would be caused to the second UE (Rx_D) may be acceptable. In this case, the first UE (Tx_A) may deprioritize an overlapping candidate resource to a lesser extent.

In addition, according to some embodiments, the first UE (Tx_A) may be configured to trigger radio resource reselection in case the first UE (Tx_A) determines that a radio resource reserved for its own transmission overlaps, at least partially, with the determined third time-frequency resource (slot and subchannel) in which the first UE (Tx_A) expects a third PSSCH transmission from the third UE (Tx_C) will be received by the second UE (Rx_D). In this way, for example, the first UE (Tx_A) may resolve a persistent collision with the third UE (Tx_C).

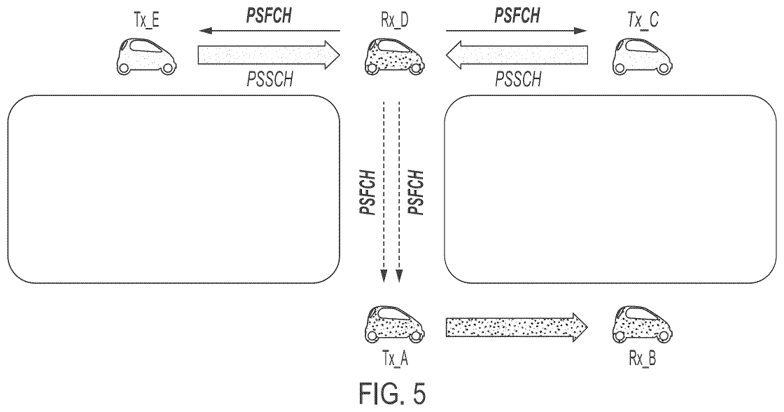

In general, the first UE (Tx_A) may be able to monitor PSFCH transmissions from the same or different receiver UEs, such as the second UE (Rx_D), corresponding to PSSCH transmissions from the same or different transmitter UEs, such as the third UE (Tx_C). FIG. 5 illustrates an example in which the transmitter UE (Tx_A) senses PSFCH transmissions corresponding to PSSCH transmissions from multiple hidden UEs, according to an embodiment. For example, as shown in the example of FIG. 5, the first UE (Tx_A) may monitor PSFCH transmissions from the second UE (Rx_D) and determine two or more distinct periodic PSSCH resources (possibly with different periodicities), e.g., from the third UE (Tx_C) and a fifth UE (Tx_E), which may both be hidden from the first UE (Tx_A). By taking advantage of the implicit PSFCH-to-PSSCH resource mapping, the first UE (Tx_A) may perform separate, unambiguous predictions of future PSSCH transmissions from the third UE (Tx_C) to the second UE (Rx_D) as well as from the fifth UE (Tx_E) to the second UE (Rx_D).

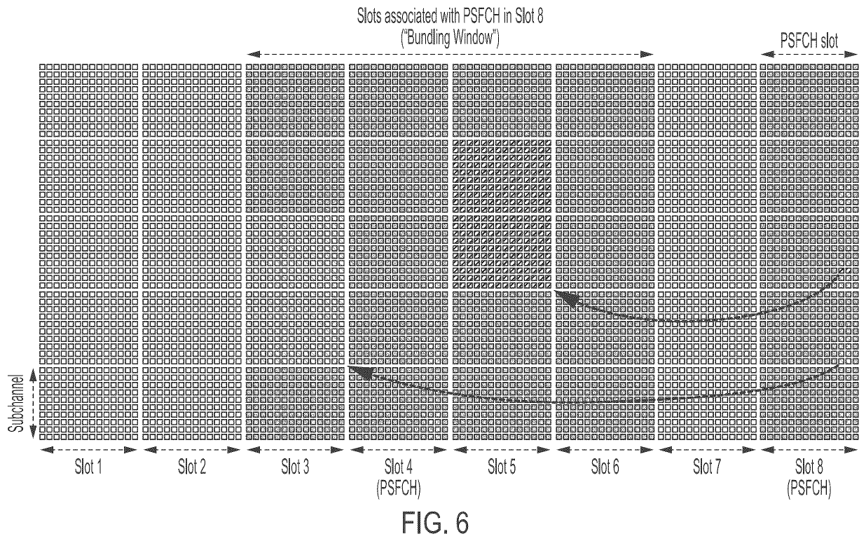

FIG. 6 illustrates an example of PSFCH-to-PSSCH resource mapping. More specifically, FIG. 6 illustrates in further detail how the first UE (Tx_A) may determine distinct time-frequency resources in which PSSCH transmissions were received by the second UE (Rx_D), e.g., from different transmitter UEs (Tx_C, Tx_E), according to an embodiment. In this example, resource pool configuration is such that PSFCH may just be transmitted in every 4^{th} slot (e.g., slot 4, slot 8, etc.), in particular in the last two Orthogonal Frequency Division Multiplexing (OFDM) symbols of the corresponding slot (excluding the last OFDM symbol, which is used as a guard interval). Each PSFCH slot is associated with a corresponding bundling window, i.e., the set of slots in which the PSSCH transmissions to be acknowledged in the PSFCH slot occur. For example, PSSCH transmissions occurring in slots 3-6 are acknowledged in PSFCH slot 8. The resource pool may be comprised of 5subchannels in frequency (indexed from 0 to 4), each comprising 10 Resource Blocks (RBs). Not all RBs within the resource pool may be configured for PSFCH transmission. In this example, the lower 4 RBs in each subchannel are configured for PSFCH transmission. The resource pool may be configured with PSFCH candidate resource type ‘startSubCH’, in which case PSFCH is transmitted in the starting subchannel of the corresponding PSSCH to be acknowledged, or with PSFCH candidate resource type ‘allocSubCH’, in which case PSFCH may be transmitted in any of the subchannels of the corresponding PSSCH to be acknowledged. In the example of FIG. 6, ‘startSubCH’ configuration is assumed.

A PSFCH transmission in a given PSFCH slot occurs in a specific RB, which depends on the time-frequency location, i.e., slot and subchannel(s), of the corresponding PSSCH transmission that is to be acknowledged. For example, the PSSCH transmission from the third UE (Tx_C) occurs in two contiguous subchannels (with subchannel indices 2 and 3) in the 3^{rd} slot within the bundling window (slot 5). Consequently, the PSFCH transmission conveying the acknowledgment (ACK or NACK) for said PSSCH transmission will occur in the 3^{rd} RB of subchannel 2 (if ‘startSubCH’ is configured, as shown) or subchannels 2 or 3 (if ‘allocSubCH’ is configured).

Similarly, the PSSCH transmission from the fifth UE (Tx_E) occurs in two contiguous subchannels (with subchannel indices 1 and 2) in the 1^{st} slot within the bundling window (slot 3). Consequently, the PSFCH transmission conveying the acknowledgment (ACK or NACK) for said PSSCH transmission will occur in the 1^{st} RB of subchannel 1 (if ‘startSubCH’ is configured, as shown) or subchannels 1 or 2 (if ‘allocSubCH’ is configured).

As a result of such implicit PSFCH-to-PSSCH resource mapping, the first UE (Tx_A) may unambiguously determine, from the monitored PSFCH transmissions by the second UE (Rx_D), the PSSCH resources (slot and at least one subchannel) in which the second UE (Rx_D) received transmissions from the third UE (Tx_C) and the fifth UE (Tx_E).

In NR sidelink, a resource pool may be configured such that the length L_{subCH} of contiguously allocated subchannels (L_{subCH}=2 in the example of FIG. 6) for a PSSCH transmission in the resource pool is constrained between a minimum (‘sl-MinSubChannelNumPSSCH’, denoted here by Lₘᵢₙ) and maximum (‘sl-MaxSubChannelNumPSSCH’, denoted here by Lₘₐₓ). The specific length L_{subCH} used for a PSSCH transmission is indicated as part of the FRIV field in the SCI format 1-A accompanying the PSSCH transmission. However, if the first UE (Tx_A) is unable to decode SCI from the third UE (Tx_C), the first UE (Tx_A) may not be able to determine the specific length L_{subCH} used for the PSSCH transmission by the third UE (Tx_C) to the second UE (Rx_D).

In case ‘startSubCH’ is configured in the resource pool, the first UE (Tx_A) can determine a slot t and starting subchannel n_{subCH}^{start} of a PSSCH transmission to be received by the second UE (Rx_D). The first UE (Tx_A) may therefore deprioritize or exclude a candidate resource for its own transmission that overlaps with the determined slot t and starting subchannel n_{subCH}^{start}. However, as the PSSCH transmission to be received by the second UE (Rx_D) is constrained to have a minimum and maximum length L_{subCH} of contiguously allocated subchannels (Lₘᵢₙ≤L_{subCH}≤Lₘₐₓ), further enhancements are possible.

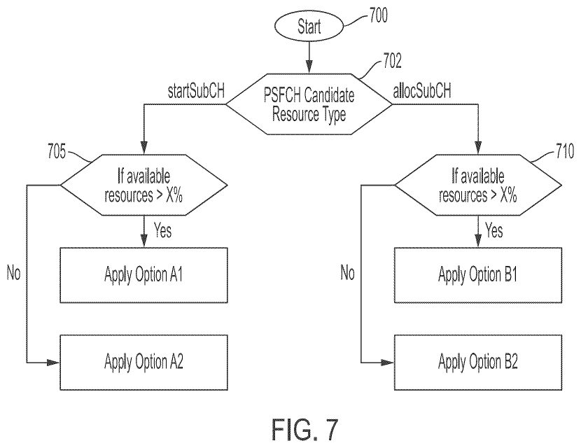

In one embodiment, denoted as Option A1 in the example of FIG. 7 discussed below, the first UE (Tx_A) may assume that the expected PSSCH transmission to be received by the second UE (Rx_D) will be comprised of L_{subCH}=Lₘₐₓ subchannels, beginning from the starting subchannel n_{subCH}^{start} (i.e., the subchannel in which the monitored PSFCH transmission(s) occurred). Thus, the first UE (Tx_A) may deprioritize or exclude any candidate resource that overlaps with at least one of the Lₘₐₓ subchannels in the determined slot t. This approach can be considered the most conservative and offers full protection (if resource exclusion is applied) from interference to the second UE (Rx_D). However, under high system load, it may be too restrictive and cause the first UE (Tx_A) to exclude too many candidate resources for its own transmission.

In a further embodiment, which is denoted as Option A2 in the example of FIG. 7, the first UE (Tx_A) may assume that the expected PSSCH transmission to be received by the second UE (Rx_D) will be comprised of Lₘᵢₙ≤L_{subCH}≤Lₘₐₓ subchannels, with different probabilities for each possible L_{subCH} value. For example, the first UE (Tx_A) may assume a uniform probability distribution between Lₘᵢₙ and Lₘₐₓ. Thus, the first UE (Tx_A) may deprioritize more aggressively (or exclude) a candidate resource that overlaps with at least one of the Lₘᵢₙ subchannels in the determined slot t (as there is no or little uncertainty that the second UE (Rx_D) will be receiving in those subchannels), while deprioritizing less aggressively a candidate resource that, for example, overlaps only with the highest possibly allocated subchannel (n_{subCH}^{start}+Lₘₐₓ−1). In particular, the degree to which the first UE (Tx_A) deprioritizes a candidate resource may depend on a probability for each possible L_{subCH} value and/or a number of overlapping subchannels between the candidate resource and the corresponding expected resource for PSSCH reception by the second UE (Rx_D).

In case ‘allocSubCH’ is configured in the resource pool, the first UE (Tx_A) can determine a slot t and subchannel n_{subCH}^{alloc} (i.e., not necessarily the starting subchannel) of a PSSCH transmission to be received by the second UE (Rx_D). The first UE (Tx_A) may therefore deprioritize or exclude a candidate resource for its own transmission that overlaps with the determined slot t and subchannel n_{subCH}^{alloc}. However, as the PSSCH transmission to be received by the second UE (Rx_D) is constrained to have a minimum and maximum length L_{subCH} of contiguously allocated subchannels (Lₘᵢₙ≤L_{subCH}≤Lₘₐₓ), further enhancements are possible.

In one embodiment, which is denoted as Option B1 in the example of FIG. 7, the first UE (Tx_A) may assume that the expected PSSCH transmission to be received by the second UE (Rx_D) will be comprised of L_{subCH}=Lₘₐₓ subchannels, possibly beginning or ending at the determined subchannel n_{subCH}^{alloc} (i.e., the subchannel in which the monitored PSFCH transmission(s) occurred). Thus, the first UE (Tx_A) may deprioritize or exclude any candidate resource that overlaps with at least one of the determined subchannel n_{subCH}^{alloc} and any of the Lₘₐₓ−1 subchannels below or above in the determined slot t. This approach is the most conservative and offers full protection (if resource exclusion is applied) from interference to the second UE (Rx_D). However, under high system load, it may be too restrictive and cause the first UE (Tx_A) to exclude too many candidate resources for its own transmission.

In a further embodiment, which is denoted as Option B2 in the example of FIG. 7, the first UE (Tx_A) may assume that the expected PSSCH transmission to be received by the second UE (Rx_D) will be comprised of Lₘᵢₙ≤L_{subCH}≤Lₘₐₓ subchannels, with different probabilities for each possible L_{subCH} value. For example, the first UE (Tx_A) may assume a uniform probability distribution between Lₘᵢₙ and Lₘₐₓ. Similarly, the first UE (Tx_A) may assume different probabilities (e.g., uniformly distributed) for each possible starting subchannel index n_{subCH}^{start} of the expected PSSCH transmission, based on the determined subchannel n_{subCH}^{alloc} (i.e., the subchannel in which the monitored PSFCH transmission(s) occurred). Thus, the first UE (Tx_A) may deprioritize more aggressively (or exclude) a candidate resource that overlaps with at least one of the determined subchannel n_{subCH}^{alloc} and any of the Lₘᵢₙ−1 subchannels below or above in the determined slot t (as there is no or little uncertainty that the second UE (Rx_D) will be receiving in those subchannels), while deprioritizing less aggressively a candidate resource that, for example, overlaps only with the highest possibly allocated subchannel (n_{subCH}^{alloc}+Lₘₐₓ−1) or lowest possibly allocated subchannel (n_{subCH}^{alloc}−Lₘₐₓ+1). In particular, the degree to which the first UE (Tx_A) deprioritizes a candidate resource may depend on a probability for each possible L_{subCH} value and/or a number of overlapping subchannels between the candidate resource and the corresponding expected resource for PSSCH reception by the second UE (Rx_D).

In case resource exclusion is applied, which of the resource exclusion options described above is applied by the first UE (Tx_A) may depend on how many candidate resources (e.g., X%) remain for the first UE (Tx_A) to select from after resource exclusion, as summarized in the example of FIG. 7. More specifically, FIG. 7 illustrates an example flow diagram depicting different resource deprioritization or exclusion options at transmitter UE (Tx_A). As illustrated, the flow diagram of FIG. 7 begins at 700 and, at 702, the PSFCH candidate resource type may be determined, i.e., whether ‘startSubCH’ or ‘allocSubCH’ is configured. As further illustrated in the example of FIGS. 7, at 705 and 710, if it is determined that available resources are greater than a certain percentage (e.g., X%), full protection (Options A1 and B1) may be provided to the second UE (Rx_D) since system load is not very high (i.e., there are enough candidate resources for the first UE (Tx_A) to select from after resource exclusion). On the other hand, when system load increases, i.e., it is determined that available resources are less than a certain percentage (e.g., X%) at 705 or 710, then uncertainty in the length of contiguously allocated subchannels of the PSSCH transmission expected to be received by the second UE (Rx_D) is taken into account (Options A2 and B2) in the resource exclusion procedure, thus increasing flexibility for the first UE (Tx_A) in its resource selection.

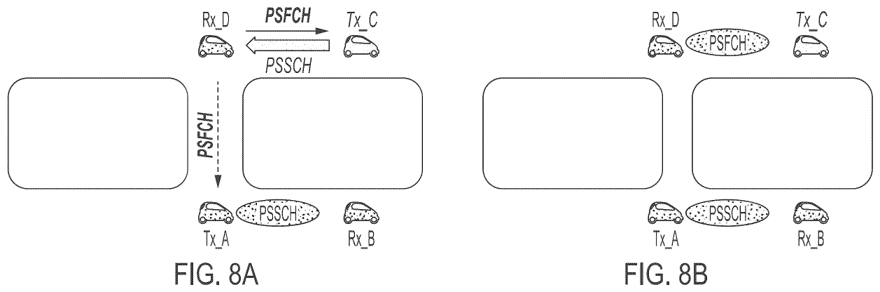

It is noted that PSFCH sensing may be particularly useful in case of beamformed PSSCH transmission/reception (e.g., in millimeter-wave frequencies (FR2)). FIGS. 8A and 8B illustrate an example of PSFCH sensing with beamforming, according to certain embodiments. As illustrated in the example of FIG. 8A, if the first UE (Tx_A) plans to use (or is using) a specific transmit beam for transmission of PSSCH (e.g., to the fourth UE (Rx_B)), it may perform PSFCH sensing within the transmit beam, rather than omni-directionally. In this way, PSFCH transmissions from UEs located outside the transmit beam (such as the second UE (Rx_D)) may not be detected, and consequently the corresponding PSSCH resources may not be excluded, deprioritized or reselected, leading to increased spatial reuse. Furthermore, as illustrated in the example of FIG. 8B, the PSFCH transmission(s) by the second UE (Rx_D) may themselves be beamformed towards the third UE (Tx_C), e.g., using the same beam as that which is used for reception of PSSCH from the third UE (Tx_C). In this case, just UEs that fall within the receive beam of the second UE (Rx_D) would detect the PSFCH transmission(s) and exclude, deprioritize or reselect the corresponding PSSCH resources, further increasing spatial reuse.

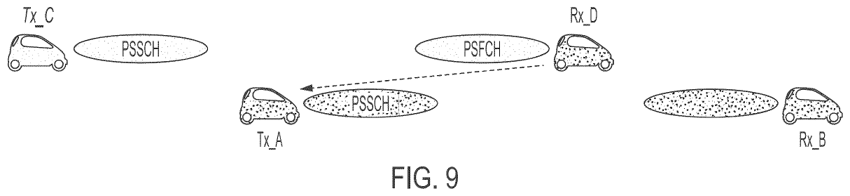

FIG. 9 illustrates another example of PSFCH sensing with beamforming, according to certain embodiments. In the example of FIG. 9, PSFCH transmissions from UEs (Rx_D) located within the transmit beam of the first UE (Tx_A) and transmitted in the direction of the first UE (Tx_A) may be detected by the first UE (Tx_A) with sufficient signal strength, and consequently the corresponding PSSCH resources may be excluded, deprioritized or reselected by the first UE (Tx_A).

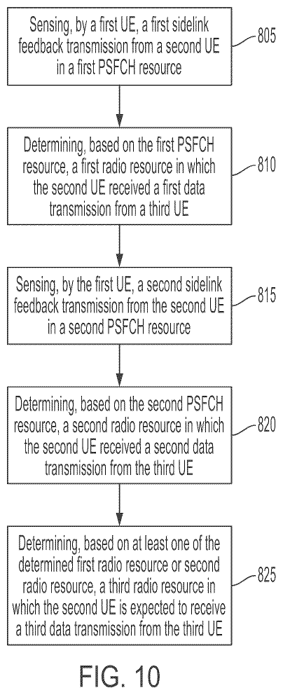

FIG. 10 illustrates an example flow diagram of a method for enhanced collision avoidance in NR sidelink, according to an example embodiment. In certain example embodiments, the flow diagram of FIG. 10 may be performed by a network entity or communication device in a communications system such as, but not limited to, LTE or 5G NR. For instance, in some example embodiments, the communication device performing the method of FIG. 10 may include a UE, sidelink (SL) UE, wireless device, mobile station, IoT device, UE type of roadside unit (RSU), other mobile or stationary device, or the like. For instance, in certain example embodiments, the method of FIG. 10 may include procedures performed by the first UE or Tx_A, as described or illustrated elsewhere herein.

As illustrated in the example of FIG. 10, the method may include, at 805, sensing, by the first UE, a first sidelink feedback transmission from a second UE (e.g., receiver UE) in a first PSFCH resource. The method may include, at 810, determining, based on the first PSFCH resource, a first radio resource in which the second UE received a first data transmission from a third UE (e.g., transmitter UE). As further illustrated in the example of FIG. 10, the method may include, at 815, sensing, by the first UE, a second sidelink feedback transmission from the second UE in a second PSFCH resource. The method may include, at 820, determining, based on the second PSFCH resource, a second radio resource in which the second UE received a second data transmission from the third UE. The method may also include, at 825, determining, based on at least one of the determined first radio resource or second radio resource, a third radio resource in which the second UE is expected to receive a third data transmission from the third UE.

According to certain embodiments, the first and second radio resources may include a same subchannel in frequency.

In one embodiment, the method may include deprioritizing or excluding from a set of candidate radio resources, for transmission by the first UE, a candidate radio resource that at least partially overlaps with the determined third radio resource. In a further embodiment, the method may include triggering radio resource reselection if the determined third radio resource at least partially overlaps with a radio resource reserved for transmission by the first UE.

According to some embodiments, at least one of the deprioritization or exclusion of the overlapping candidate radio resource or the triggering of radio resource reselection may be based on a measured signal strength of the first or second sidelink feedback transmissions. In certain embodiments, at least one of the deprioritization or exclusion of the overlapping candidate radio resource or the triggering of radio resource reselection may be based on a number of periodically recurring data transmissions determined by the first UE based on sensed sidelink feedback transmissions from the second UE. According to an embodiment, at least one of the deprioritization or exclusion of the overlapping candidate radio resource or the triggering of radio resource reselection may be based on a number of overlapping subchannels.

In an embodiment, at least one of the deprioritization or exclusion of the overlapping candidate radio resource or the triggering of radio resource reselection is based on a probability distribution over a number of contiguous subchannels for the third data transmission. According to certain embodiments, the probability distribution over the number of contiguous subchannels for the third data transmission is determined based on at least one of a configured minimum or maximum number of contiguous subchannels.

According to one embodiment, at least one of the deprioritization or exclusion of the overlapping candidate radio resource or the triggering of radio resource reselection may be based on a probability distribution over a starting subchannel for the third data transmission. In an embodiment, the probability distribution over the starting subchannel for the third data transmission may be determined based on a determined subchannel of at least one of the first data transmission or second data transmission.

In some embodiments, the determined third radio resource may include a configured minimum or maximum number of contiguous subchannels for the third data transmission, starting with a determined subchannel of at least one of the first data transmission or second data transmission. According to an embodiment, the determined third radio resource may include all subchannels located, with respect to a determined subchannel of at least one of the first data transmission or second data transmission, within a distance smaller than a configured minimum or maximum number of contiguous subchannels for the third data transmission.

According to some embodiments, the exclusion of the overlapping candidate radio resource may depend on a remaining fraction of non-excluded candidate radio resources. In an embodiment, the sensing of the first sidelink feedback transmission 805 and/or the sensing of the second sidelink feedback transmission 815 may be performed on a beam being used or to be used for transmission by the first user equipment.

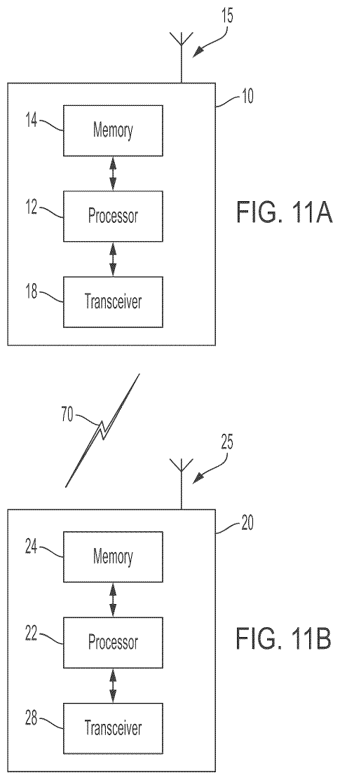

FIG. 11A illustrates an example of an apparatus 10 according to an embodiment. In an embodiment, apparatus 10 may be a node, host, or server in a communications network or serving such a network. For example, apparatus 10 may be a UE, mobile equipment (ME), mobile station, mobile device, stationary device, IoT device, TSN device, or other device. As described herein, UE may alternatively be referred to as, for example, a mobile station, mobile equipment, mobile unit, mobile device, user device, subscriber station, wireless terminal, tablet, smart phone, IoT device, sensor or NB-IoT device, or the like. As one example, apparatus 10 may be implemented in, for instance, a wireless handheld device, a wireless plug-in accessory, or the like. It should be noted that one of ordinary skill in the art would understand that apparatus 10 may include components or features not shown in FIG. 11A.

As illustrated in the example of FIG. 11A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 11A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources. In certain examples, processor 12 may be configured as a processing means or controlling means for executing any of the procedures described herein.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein. In certain example embodiments, memory 14 may be configured as a storing means for storing any information or instructions for execution as discussed elsewhere herein.

In an example embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some example embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. In certain example embodiments, transceiver 18 may be configured as a transceiving means for transmitting or receiving information as discussed elsewhere herein. Additionally or alternatively, in some embodiments, apparatus 10 may include an input and/or output device (I/O device) or an input/output means.

In an example embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some example embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may include a UE (e.g., SL UE), TSN device, mobile device, mobile station, ME, IoT device and/or NB-IoT device, for example. For example, in some embodiments, apparatus 10 may be configured to perform one or more of the processes depicted in any of the flow charts or signaling diagrams described herein. According to an embodiment, apparatus 10 may be controlled by memory 14 and processor 12 to perform one or more of the procedures illustrated in the method of FIG. 7 and/or FIG. 10. In some embodiments, as discussed herein, apparatus 10 may be configured to perform a procedure relating to providing enhanced collision avoidance in NR sidelink, for instance.

FIG. 11B illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, TSN device, or other device. As described herein, UE may alternatively be referred to as, for example, a mobile station, mobile equipment, mobile unit, mobile device, user device, subscriber station, wireless terminal, tablet, smart phone, IoT device, sensor or NB-IoT device, or the like. As one example, apparatus 20 may be implemented in, for instance, a wireless handheld device, a wireless plug-in accessory, or the like. In another embodiment, apparatus 20 may be a satellite, base station, a Node B, an evolved Node B (eNB), 5G Node B or access point, next generation Node B (NG- NB or gNB), HAPS, and/or WLAN access point, associated with a radio access network, such as a LTE network, 5G or NR.

It should be understood that, in some example embodiments, apparatus 20 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 20 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 20 may include components or features not shown in FIG. 11B.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 11B.

As illustrated in the example of FIG. 11B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field- programmable gate arrays (FPGAs), application-specific integrated circuits (ASICs), and processors based on a multi-core processor architecture, as examples. While a single processor 22 is shown in FIG. 11B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device), and/or input/output means. In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link or interface 70 according to any radio access technology, such as NR or SL.

According to some embodiments, processor 22 and memory 24 may be included in or may form a part of processing circuitry/means or control circuitry/means. In addition, in some embodiments, transceiver 28 may be included in or may form a part of transceiving circuitry or transceiving means.

As discussed above, according to some embodiments, apparatus 20 may be a UE (e.g., SL UE), TSN device, mobile device, mobile station, ME, IoT device and/or NB-IoT device, for example. According to certain embodiments, apparatus 20 may be controlled by memory 24 and processor 22 to perform the functions associated with example embodiments described herein. For example, in some embodiments, apparatus 20 may be configured to perform one or more of the processes depicted in any of the flow charts or signaling diagrams described herein, such as those illustrated in FIG. 7 and/or FIG. 10. In certain embodiments, apparatus 20 may include or represent a UE, such as one or more of the UE(s) illustrated in the figures and discussed elsewhere herein. According to an embodiment, apparatus 20 may be configured to perform a procedure relating to enhanced collision avoidance in NR sidelink, for instance.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, sensors, circuits, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, certain example embodiments can improve or enhance collision avoidance in sidelink implementations by exploiting the implicit resource mapping between PSSCH and PSFCH. Example embodiments advantageously result in no added signaling or overhead. Accordingly, the use of certain example embodiments results in improved functioning of communications networks and their nodes, such as base stations, eNBs, gNBs, and/or IoT devices, UEs or mobile stations, or the like.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1.-33. (canceled)

34. An apparatus, comprising:
at least one processor; and
at least one memory comprising computer program code,
the at least one memory and computer program code configured, with the at least one processor, to cause the apparatus at least to:
sense a first sidelink feedback transmission from a receiver user equipment (UE) in a first Physical Sidelink Feedback Channel (PSFCH) resource;
determine, based on the first Physical Sidelink Feedback Channel (PSFCH) resource, a first radio resource in which the receiver user equipment (UE) received a first data transmission from a transmitter user equipment (UE);
sense a second sidelink feedback transmission from the receiver user equipment (UE) in a second Physical Sidelink Feedback Channel (PSFCH) resource;
determine, based on the second Physical Sidelink Feedback Channel (PSFCH) resource, a second radio resource in which the receiver user equipment (UE) received a second data transmission from the transmitter user equipment (UE); and
determine, based on at least one of the determined first radio resource or second radio resource, a third radio resource in which the receiver user equipment (UE) is expected to receive a third data transmission from the transmitter user equipment (UE).

35. The apparatus of claim 34, wherein at least one of:
the apparatus comprises a user equipment (UE); and
the first and second radio resources comprise a same subchannel in frequency; and
the at least one memory and computer program code are configured, with the at least one processor, to cause the apparatus at least to:
deprioritize or exclude from a set of candidate radio resources, for transmission by the apparatus, a candidate radio resource that at least partially overlaps with the determined third radio resource
wherein the at least one memory and computer program code are configured, with the at least one processor, to cause the apparatus at least to:
trigger radio resource reselection if the determined third radio resource at least partially overlaps with a radio resource reserved for transmission by the apparatus.

36. The apparatus of claim 35, wherein:
at least one of the deprioritization or exclusion of the overlapping candidate radio resource or the triggering of radio resource reselection is based on a measured signal strength of the first or second sidelink feedback transmissions; or
at least one of the deprioritization or exclusion of the overlapping candidate radio resource or the triggering of radio resource reselection is based on a number of periodically recurring data transmissions determined by the apparatus based on sensed sidelink feedback transmissions from the receiver user equipment (UE); or
at least one of the deprioritization or exclusion of the overlapping candidate radio resource or the triggering of radio resource reselection is based on a number of overlapping subchannels.

37. The apparatus of claim 35, wherein at least one of the deprioritization or exclusion of the overlapping candidate radio resource or the triggering of radio resource reselection is based on a probability distribution over a number of contiguous subchannels for the third data transmission.

38. The apparatus of claim 37, wherein the probability distribution over the number of contiguous subchannels for the third data transmission is determined based on at least one of a configured minimum or maximum number of contiguous subchannels.

39. The apparatus of claim 35, wherein at least one of the deprioritization or exclusion of the overlapping candidate radio resource or the triggering of radio resource reselection is based on a probability distribution over a starting subchannel for the third data transmission.

40. The apparatus of claim 39, wherein the probability distribution over the starting subchannel for the third data transmission is determined based on a determined subchannel of at least one of the first or second data transmission.

41. The apparatus of claim 34, wherein the determined third radio resource comprises a configured minimum or maximum number of contiguous subchannels for the third data transmission, starting with a determined subchannel of at least one of the first transmission or second data transmission.

42. The apparatus of claim 34, wherein the determined third radio resource comprises all subchannels located, with respect to a determined subchannel of at least one of the first data transmission or second data transmission, within a distance smaller than a configured minimum or maximum number of contiguous subchannels for the third data transmission.

43. The apparatus of claim 35, wherein the exclusion of the overlapping candidate radio resource depends on a remaining fraction of non-excluded candidate radio resources.

44. The apparatus of claim 34, wherein the sensing of at least one of the first sidelink feedback transmission or the second sidelink feedback transmission is performed on a beam being used or to be used for transmission by the apparatus.

45. A method, comprising:
sensing, by a first user equipment, a first sidelink feedback transmission from a second user equipment (UE) in a first Physical Sidelink Feedback Channel (PSFCH) resource;
determining, based on the first Physical Sidelink Feedback Channel (PSFCH) resource, a first radio resource in which the second user equipment (UE) received a first data transmission from a third user equipment (UE);
sensing, by the first user equipment, a second sidelink feedback transmission from the second user equipment (UE) in a second Physical Sidelink Feedback Channel (PSFCH) resource;
determining, based on the second Physical Sidelink Feedback Channel (PSFCH) resource, a second radio resource in which the second user equipment (UE) received a second data transmission from the third user equipment (UE); and
determining, based on at least one of the determined first radio resource or second radio resource, a third radio resource in which the second user equipment (UE) is expected to receive a third data transmission from the third user equipment (UE).

46. The method of claim 45, wherein at least one of:
the first and second radio resources comprise a same subchannel in frequency; and
the determined third radio resource comprises a configured minimum or maximum number of contiguous subchannels for the third data transmission, starting with a determined subchannel of at least one of the first data transmission or second data transmission; and
the determined third radio resource comprises all subchannels located, with respect to a determined subchannel of at least one of the first data transmission or second data transmission, within a distance smaller than a configured minimum or maximum number of contiguous subchannels for the third data transmission.

47. The method of claim 45, further comprising one of:
deprioritizing or excluding from a set of candidate radio resources, for transmission by the first user equipment (UE), a candidate radio resource that at least partially overlaps with the determined third radio resource; or
triggering radio resource reselection if the determined third radio resource at least partially overlaps with a radio resource reserved for transmission by the first user equipment (UE).

48. The method of claim 47, wherein:
at least one of the deprioritization or exclusion of the overlapping candidate radio resource or the triggering of radio resource reselection is based on a measured signal strength of the first or second sidelink feedback transmissions; or
at least one of the deprioritization or exclusion of the overlapping candidate radio resource or the triggering of radio resource reselection is based on a number of periodically recurring data transmissions determined by the first user equipment (UE) based on sensed sidelink feedback transmissions from the second user equipment (UE); or
at least one of the deprioritization or exclusion of the overlapping candidate radio resource or the triggering of radio resource reselection is based on a number of overlapping subchannels.

49. The method of claim 47, wherein at least one of the deprioritization or exclusion of the overlapping candidate radio resource or the triggering of radio resource reselection is based on a probability distribution over a number of contiguous subchannels for the third data transmission.

50. The method of claim 49, wherein the probability distribution over the number of contiguous subchannels for the third data transmission is determined based on at least one of a configured minimum or maximum number of contiguous subchannels.

51. The method of claims 47, wherein at least one of the deprioritization or exclusion of the overlapping candidate radio resource or the triggering of radio resource reselection is based on a probability distribution over a starting subchannel for the third data transmission.

52. The method of claim 51, wherein the probability distribution over the starting subchannel for the third data transmission is determined based on a determined subchannel of at least one of the first or second data transmission.

53. An apparatus, comprising:
means for performing the method according to claim 45.
